(19) United States
(12) Patent Application Publication
(10) Pub. No.: US 2025/0229238 A1
(43) Pub. Date: Jul. 17, 2025

(54) DISPERSER PUMP

(71) Applicant: OBSHCHESTVO S OGRANICHENNOI OTVETSTVENNOSTIU "AMATEC", Moscow (RU)

(72) Inventors: Igor Anatolevich STAVRULOV, Moscow (RU); Mohsen ZEHTABCHIAN, Toronto (CA)

(21) Appl. No.: 18/697,679

(22) PCT Filed: Jun. 15, 2023
(86) PCT No.: PCT/RU2023/000184

§ 371 Date: Apr. 1, 2024

(30) Foreign Application Priority Data
Jun. 13, 2023 (RU) 2023115417

(51) Int. Cl. B01F 27/1143; F04C 3/02; F04C 15/00

(52) U.S. Cl. CPC B01F 27/1143; F04C 3/02; F04C 15/00

(57) ABSTRACT

The invention relates to disperser pumps designed for pumping, intensive mixing and dispersing multi-phase fluids and, in particular, water-mineral binding mixtures and other liquid fluids containing solid particles. The technical result of the invention is a regulated combination of two processes in the same apparatus, such as pumping the working fluids (pump function) and intensive mixing (dispersion/disintegration/homogenization function), with no stagnant zones in the working chamber of the pump, and all surfaces within the working chamber of the pump are self-cleaned during the rotation of shafts. The disperser pump for pumping liquid fluids with solid particles comprises the housing with pressure and suction pipes, in which there are two shafts that rotate in the same direction and have screw threads. In the end of the working chamber, the cam-driven elements are additionally mounted on the shafts in front of the pressure pipe, wherein the shafts rotate at a speed of 800-4500 rpm.

### PRIOR ART

A pump for multi-phase fluids is known from the prior art, as it was disclosed in SU 1828947 U1 published on Jul. 23, 1993 (a prototype). The pump comprises a body with a working chamber, the chamber comprising: a pressure chamber for pumped fluids, a suction chamber for pumped fluids and two screw-threaded shafts rotating in the same direction.

The disadvantage of the technical solution disclosed above is that the working chamber has too many surfaces that cannot be cleaned during the pump operation. In addition, this technical solution did not set the objective of increasing the mixing degree of the pumped fluid. Moreover, screw pumps of this type are used primarily to pump mixtures that must be subjected to a minimum of intensive agitation, which may result in deterioration of the mixture properties. At the same time, such apparatus can increase the degree of mixing of pumped fluids only by indirect means, in particular, by adjusting the pumped flow restriction or by increasing the rotation speed of the shafts, which is not always feasible from a technological point of view.

### TECHNICAL FIELD

The invention relates to disperser pumps designed for pumping, intensive mixing and dispersing multi-phase fluids, primarily those with water-mineral binders and, in particular, water mixtures with gypsum, cement, magnesia binders, lime, and other fluids containing, among other things, solid particles.

### SUMMARY OF THE INVENTION

The objective of the claimed invention is to develop a twin-screw disperser pump combining 2 following functions in the same apparatus:
Pressurizing/pumping the process fluid.
Intensive mixing/dispersing, which is the main function of the claimed apparatus for considered processes and materials.

For this purpose, an additional zone is created within the pump where the shafts rotating in one direction contain additionally mounted stirring cams.

The technical result of the invention is a regulated combination of two processes in the same apparatus, such as pumping the working fluid (pump function) and intensive mixing (dispersion/disintegration/homogenization function), with no stagnant zones in the working chamber of the pump, and all surfaces within the working chamber of the pump are self-cleaned during the rotation of shafts.

The said technical result is achieved because a disperser pump for pumping fluids, including those with solid particles, comprises a body with pressure and suction pipes located in different parts of the pump body wherein, in the body, there is a working chamber, which has two shafts that rotate in the same direction, have parallel axes, and have screw threads. In the working chamber, the cams performing the function of intense mixing/dispersing are additionally mounted on the shafts in front of the pressure pipe, wherein the shafts rotate at a speed of 800-4500 rpm. Varying the length of the screw thread zone and the cams zone allows for the regulation of the pumping and mixing process within a wide range of values.

The screw threads and cams can be designed with the possibility of self-cleaning.

The disperser pump comprises a motor, a safety coupling and a gearbox, wherein the pump body and the gearbox are separated by a gap.

The disperser pump is designed for pumping, intensive mixing and dispersing multi-phase fluids, primarily those with mineral hydraulic binders, in particular water mixtures with gypsum, cement, magnesia binders, lime, and other fluids containing, among other things, solid particles.

### BRIEF DESCRIPTION OF THE DRAWINGS

The invention will become clearer from the description that is not restrictive and is provided with reference to the accompanying drawings, which show the following:

FIG. 1—General view of the assembled pump

FIG. 2—General view of working parts of the disperser pump

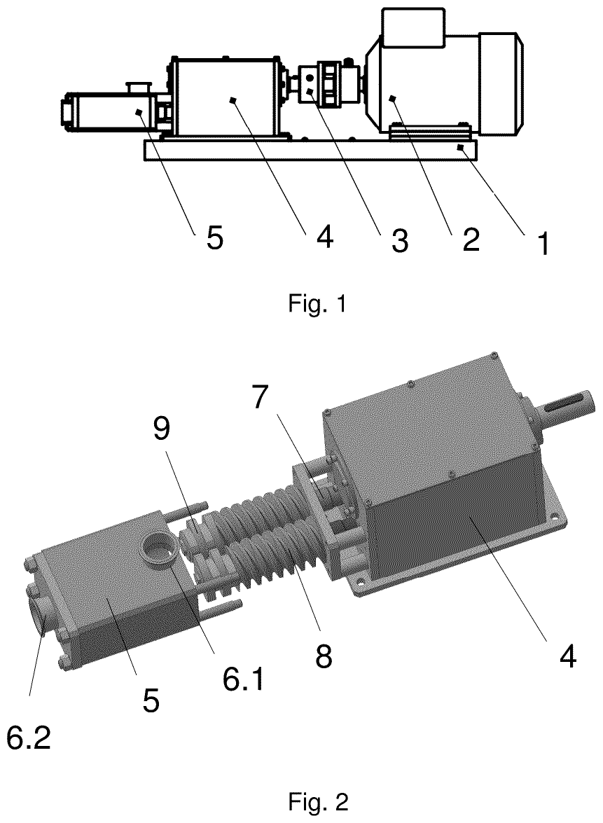

1—base of the disperser pump; 2—motor; 3—safety coupling; 4—gearbox; 5—body of the disperser pump; 6.1—suction pipe; 6.2—pressure pipe; 7—shafts of the disperser pump; 8—screw threads of the disperser pump; 9—cams of the disperser pump.

### EMBODIMENT OF THE INVENTION

The disperser pump for pumping liquid fluids with solid particles comprises a body (5) with pressure (6.2) and suction (6.1) pipes located in different parts of the pump body (5) wherein, within the body (5), there is a working chamber, in which there are two shafts (7) that rotate in the same direction, have parallel axes, and have screw threads (8). In the working chamber, the cams (9) are additionally mounted on the shafts in front of the pressure pipe, wherein the shafts rotate at a speed of 800-4500 rpm.

The suction (6.1) and pressure (6.2) pipes can be inserted into the top, bottom, or side surface of the pump body (5) or inserted into the butt end of the pump body, as shown in FIG. 2. The placement of tubes is determined by the direction selected for the movement of pumped and mixed fluids (the fluids can move both towards the motor and away from the motor) and by the spatial location of the disperser pump in the production line.

The screw threads (8) and cams (9) are designed such that they can perform the function of self-cleaning. The screw threads (8) and cams (9) can be removable components mounted on the shafts, or the shafts can be manufactured with screw threads and cam.

The disperser pump comprises the motor and gearbox mounted on the base (1), wherein the pump base (5) and the body of the gearbox (4) separated by a gap to easily check the condition of the glands.

The disperser pump is made to allow pumping, intensive mixing and dispersing multi-phase fluids, primarily those with mineral hydraulic binders, in particular water mixtures with gypsum, cement, magnesia binders, lime, and other fluids containing, among other things, solid particles, including the filler.

The disperser pump operates as follows. When the motor (2) is switched on, this rotates the motor shaft, which transmits rotation to the drive shaft of the gearbox (4) via the safety coupling (3). The drive shaft of the gearbox transmits rotation to two shafts (7) of the pump, which rotate in one direction. The gearbox (4) is connected to the pump body (5) through coupling sleeves, which creates a gap between the gearbox (4) and the pump body (5). Through the suction pipe (6.1), the pumped fluid enters the disperser pump's working chamber, in which the pump shafts (7) rotate in one direction, wherein the said shafts have screw threads (8) that transport the fluid to the pressure pipe (6.2). The cams (9) are installed on shafts in the zone before the pressure pipe to mix (disperse, disintegrate, homogenize) the specified fluid. When the pump shafts (7) rotate in one direction, the protruding elements located on the screw threads (8) and cams (9) perform a scraping motion in relation to the other elements of the disperser pump, as a result of which the walls of the pump's working chamber and the surfaces of the screw threads (8) and cams (9) have no areas that would be without being cleaned of potentially stuck fluids. The dispersed fluid is then discharged from the disperser pump through the pressure pipe and transported to the next production stage.

The change in the shaft speed directly affects the pumping and dispersing process. Higher rotation speed increases the volume of the pumped fluids and the mixing degree (within the permitted range determined by the pumped fluids). By changing the cross-sectional area of the output flow, it is possible to further adjust the pumping and mixing process parameters. The length and configuration of the screw thread and cams can be changed to regulate the volume and mixing degree of the fluids. Therefore, the disperser pump according to the present technical solution allows to regulate, within a wide range, the disperser pump characteristics in terms of pumping volume and dispersion degree.

The screw threads and cams can be manufactured as a whole piece or assembled from individual screw thread and cams, which allows to vary the length of the assembled screw threads and the length of the intensive mixing zone.

The claimed disperser pump allows to organize the process of pumping the fluids, including the one with solid particles, and simultaneously ensuring its intensive mixing (dispersion/disintegration/homogenization), wherein the volume of the pump's working chamber has no stagnant zones, because the inner space of the working chamber, that is made hollow in the form of two crossed cylinders, is completely filled with rotating elements, which allows to clean all internal surfaces of the pump's working chamber when the screw threads and cams are self-cleaning during the rotation of shafts. In addition, for the ease of maintenance, the body of the pump and the gearbox are mounted with a gap between them, which allows to visually check the condition of the glands.

The invention has been disclosed above with reference to its particular embodiment. Other embodiments of the invention that do not change the essence of the invention as disclosed in this description may also be apparent to those skilled in the art. Accordingly, the invention should be considered limited in scope only by the claims below.

1. A disperser pump for pumping multi-phase liquid fluids comprising a body with pressure and suction pipes located in different parts of the pump body wherein, within the body, there is a working chamber, in which there are two shafts that rotate in the same direction, have parallel axes, and have screw threads and are characterized in that, in the end of the working chamber, the cams are additionally mounted on the shafts in front of the pressure pipe, wherein the shafts rotate at a speed of 800-4500 rpm.

2. The disperser pump according to claim 1 wherein it uses the water-mineral mixtures containing mineral binders, that are selected from the group of gypsum, cement, magnesia binders and lime-containing binders, as the multi-phase fluids.

3. The disperser pump according to claim 2 wherein the water-mineral mixtures additionally contain the fillers.

4. The disperser pump according to claim 1 wherein the screw threads and cams are made to allow their self-cleaning.

5. The disperser pump according to claim 1 wherein the screw threads and cams are assembled from separate screw thread and cams.
